(19) United States
(12) Patent Application Publication
(10) Pub. No.: US 2025/0097867 A1
(43) Pub. Date: Mar. 20, 2025

(54) TECHNIQUES FOR SYNCHRONIZATION SIGNAL BLOCK AND CONTROL RESOURCE SET INDICATION

(71) Applicant: QUALCOMM Incorporated, San Diego, CA (US)

(72) Inventors: Jae Ho RYU, San Diego, CA (US); Le LIU, San Jose, CA (US); James BECKMAN, La Jolla, CA (US); Yongle WU, San Diego, CA (US); Lei XIAO, San Jose, CA (US); Prashant SHARMA, San Marcos, CA (US)

(21) Appl. No.: 18/761,577

(22) Filed: Jul. 2, 2024

Related U.S. Application Data
(60) Provisional application No. 63/583,558, filed on Sep. 18, 2023.

(51) Int. Cl. H04W 56/00; H04W 72/0457; H04W 72/232

(52) U.S. Cl. CPC H04W 56/0015; H04W 72/0457; H04W 72/232

(57) ABSTRACT

Various aspects of the present disclosure generally relate to wireless communication. In some aspects, a user equipment (UE) may receive configuration information associated with a secondary cell (SCell), wherein the SCell has a narrowband channel bandwidth. The UE may receive a synchronization signal block (SSB) on the SCell in accordance with an SSB bandwidth configuration, wherein the SSB bandwidth configuration is associated with at least one of: the configuration information, or a frequency of the SSB being identified by a synchronization raster, wherein the synchronization raster is for cells having the narrowband channel bandwidth. The UE may monitor an initial control resource set (CORESET) using a CORESET bandwidth configuration associated with the configuration information. Numerous other aspects are described.

### CROSS-REFERENCE TO RELATED APPLICATION

This Patent application claims priority to U.S. Provisional Patent Application No. 63/583,558, filed on Sep. 18, 2023, entitled “TECHNIQUES FOR SYNCHRONIZATION SIGNAL BLOCK AND CONTROL RESOURCE SET INDICATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for synchronization signal block (SSB) and control resource set (CORESET) indication.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

In some aspects, a method of wireless communication performed by a user equipment (UE) includes receiving configuration information associated with a secondary cell (SCell), wherein the SCell has a narrowband channel bandwidth; receiving a synchronization signal block (SSB) on the SCell in accordance with an SSB bandwidth configuration, wherein the SSB bandwidth configuration is associated with at least one of: the configuration information, or a frequency of the SSB being identified by a synchronization raster, wherein the synchronization raster is for cells having the narrowband channel bandwidth; and monitoring an initial control resource set (CORESET) using a CORESET bandwidth configuration associated with the configuration information.

In some aspects, a method of wireless communication performed by a network node includes transmitting configuration information associated with a SCell, wherein the SCell has a narrowband channel bandwidth; transmitting a SSB on the SCell in accordance with an SSB bandwidth configuration, wherein the SSB bandwidth configuration is associated with at least one of: the configuration information, or a frequency of the SSB being identified by a synchronization raster for cells having the narrowband channel bandwidth; and transmitting a communication on an initial CORESET using a CORESET bandwidth configuration associated with the configuration information.

In some aspects, an apparatus for wireless communication at a UE includes one or more memories; and one or more processors, coupled to the one or more memories, configured to cause the UE to: receive configuration information associated with a SCell, wherein the SCell has a narrowband channel bandwidth; receive a SSB on the SCell in accordance with an SSB bandwidth configuration, wherein the SSB bandwidth configuration is associated with at least one of: the configuration information, or a frequency of the SSB being identified by a synchronization raster, wherein the synchronization raster is for cells having the narrowband channel bandwidth; and monitor an initial CORESET using a CORESET bandwidth configuration associated with the configuration information.

In some aspects, an apparatus for wireless communication at a network node includes one or more memories; and one or more processors, coupled to the one or more memories, configured to cause the network node to: transmit configuration information associated with a SCell, wherein the SCell has a narrowband channel bandwidth; transmit a SSB on the SCell in accordance with an SSB bandwidth configuration, wherein the SSB bandwidth configuration is associated with at least one of: the configuration information, or a frequency of the SSB being identified by a synchronization raster for cells having the narrowband channel bandwidth; and transmit a communication on an initial CORESET using a CORESET bandwidth configuration associated with the configuration information.

In some aspects, a non-transitory computer-readable medium storing a set of instructions for wireless communication includes one or more instructions that, when executed by one or more processors of a UE, cause the UE to: receive configuration information associated with a SCell, wherein the SCell has a narrowband channel bandwidth; receive a SSB on the SCell in accordance with an SSB bandwidth configuration, wherein the SSB bandwidth configuration is associated with at least one of: the configuration information, or a frequency of the SSB being identified by a synchronization raster, wherein the synchronization raster is for cells having the narrowband channel bandwidth; and monitor an initial CORESET using a CORESET bandwidth configuration associated with the configuration information.

In some aspects, a non-transitory computer-readable medium storing a set of instructions for wireless communication includes one or more instructions that, when executed by one or more processors of a network node, cause the network node to: transmit configuration information associated with a SCell, wherein the SCell has a narrowband channel bandwidth; transmit a SSB on the SCell in accordance with an SSB bandwidth configuration, wherein the SSB bandwidth configuration is associated with at least one of: the configuration information, or a frequency of the SSB being identified by a synchronization raster for cells having the narrowband channel bandwidth; and transmit a communication on an initial CORESET using a CORESET bandwidth configuration associated with the configuration information.

In some aspects, an apparatus for wireless communication includes means for receiving configuration information associated with a SCell, wherein the SCell has a narrowband channel bandwidth; means for receiving a SSB on the SCell in accordance with an SSB bandwidth configuration, wherein the SSB bandwidth configuration is associated with at least one of: the configuration information, or a frequency of the SSB being identified by a synchronization raster, wherein the synchronization raster is for cells having the narrowband channel bandwidth; and means for monitoring an initial CORESET using a CORESET bandwidth configuration associated with the configuration information.

In some aspects, an apparatus for wireless communication includes means for transmitting configuration information associated with a SCell, wherein the SCell has a narrowband channel bandwidth; means for transmitting a SSB on the SCell in accordance with an SSB bandwidth configuration, wherein the SSB bandwidth configuration is associated with at least one of: the configuration information, or a frequency of the SSB being identified by a synchronization raster for cells having the narrowband channel bandwidth; and means for transmitting a communication on an initial CORESET using a CORESET bandwidth configuration associated with the configuration information.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a synchronization signal (SS) hierarchy, in accordance with the present disclosure.

FIG. 5 is a diagram illustrating an example resource structure for wireless communication, in accordance with the present disclosure.

FIG. 6 is a diagram illustrating an example of synchronization (sync) rasters, in accordance with the present disclosure.

FIG. 7 is a diagram illustrating an example of signaling associated with synchronization signal block (SSB) bandwidth configuration and/or control resource set (CORESET) bandwidth configuration indication, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

A radio access technology (RAT) may implement communication between wireless communication devices via carriers or cells. A user equipment (UE) communicating on a carrier or cell may be configured with a channel bandwidth. A channel bandwidth may define a bandwidth within which the UE is configured to communicate. The channel bandwidth of a UE may be narrower than a total bandwidth of the carrier. For example, a carrier may have a 100 MHz bandwidth, and UEs connected to the carrier may communicate using channel bandwidths of 20 MHz, 10 MHz, 5 MHz, or the like.

A RAT (e.g., 5G/NR) may implement channel bandwidths that are less than 5 MHz. Some iterations of 5G/NR support channel bandwidths as small as 5 MHz, but no smaller. However, recent developments support the deployment of cells (e.g., carriers) supporting channel bandwidths of 3 MHz up to 5 MHz. For example, a UE configured with a channel bandwidth between 3 MHz and 5 MHZ (inclusive of 3 MHz and not inclusive of 5 MHz) may be said to have a narrowband channel bandwidth. In some examples, a narrowband channel bandwidth is defined as a channel bandwidth between approximately 3 MHz and 5 MHz (inclusive of 3 MHz and not inclusive of 5 MHz).

A cell may be associated with a synchronization signal block (SSB) and an initial control resource set (CORESET), sometimes referred to as CORESET #0. The SSB may be used to synchronize in time and frequency with the cell. The initial CORESET may include a physical downlink control channel (PDCCH) with downlink control information (DCI) indicating a configuration for receiving system information block (SIB) 1. For a standalone deployment including only a primary cell (PCell), an SSB may be mandated to occur on a frequency defined by a synchronization raster. This is because the UE may search for SSBs on these predefined frequencies to identify the PCell and perform initial access. There may be a first set of synchronization rasters for channel bandwidths larger than or equal to 5 MHz, and a second set of synchronization rasters for channel bandwidths smaller than 5 MHz. Thus, the UE can differentiate whether a PCell has a channel bandwidth less than 5 MHz, by reference to which set of synchronization rasters the corresponding SSB is received on. This may enable the UE to identify an SSB bandwidth configuration of the SSB, such as by reference to a table that indicates SSB bandwidth configurations associated with different channel rasters.

Furthermore, for a standalone deployment's PCell, an SSB may carry an indication of a CORESET configuration, which may indicate a multiplexing pattern, a configured bandwidth of the CORESET, a number of symbols of the CORESET, and an offset of the CORESET. Again, there may be a first table of CORESET configurations for channel bandwidths larger than or equal to 5 MHz, and a second table of CORESET configurations for channel bandwidths smaller than 5 MHz. Thus, the UE can determine a CORESET bandwidth configuration by reference to a table of CORESET configurations corresponding to a channel bandwidth derived from the SSB.

Once a connection is established on a PCell, a UE can be configured with one or more secondary cells (SCells) via signaling on the PCell, such as in a carrier aggregation or dual connectivity configuration. “SCell” can also refer to a primary secondary cell (PSCell). It may be beneficial to support configuration of SCells having channel bandwidths smaller than 5 MHz. On an SCell, the SSB may or may not occur on a frequency defined by a synchronization raster. For example, the SSB can be configured to occur at an arbitrary frequency. If the SSB occurs at a frequency other than a frequency defined by a synchronization raster corresponding to a channel bandwidth of the UE (e.g., a synchronization raster for channel bandwidths larger than or equal to 5 MHz, or a synchronization raster for channel bandwidths smaller than 5 MHz), it may be difficult for the UE to identify a CORESET bandwidth configuration and/or an SSB bandwidth configuration for the SCell. Furthermore, even if the SSB occurs on a frequency defined by a synchronization raster, it may be unclear whether the CORESET bandwidth configuration and/or SSB bandwidth configuration should be the same as for a PCell whose SSB occurs on the frequency defined by the synchronization raster. Thus, deployment of narrow bandwidths (e.g., less than 5 MHz) for non-standalone (e.g., carrier aggregation or dual connectivity) is hampered, leading to less efficient utilization of network resources and decreased support for low-capability devices.

Aspects of the present disclosure relate generally to narrowband communication. Some aspects more specifically relate to identifying bandwidth configurations of an SSB and an initial CORESET on an SCell with a narrowband channel bandwidth. In some aspects, a UE may receive configuration information associated with an SCell that has a narrowband channel bandwidth (e.g., less than 5 MHz). The UE may receive an SSB on the SCell in accordance with an SSB bandwidth configuration, which may indicate a number of physical resource blocks (PRBs) and/or one or more punctured PRBs of the SSB. “PRB” is used interchangeably herein with “RB.” The UE may monitor for an initial CORESET using a CORESET bandwidth configuration, which may indicate a number of PRBs and/or one or more punctured PRBs of the initial CORESET. Thus, deployment of narrow bandwidths (e.g., less than 5 MHz) for non-standalone (e.g., carrier aggregation or dual connectivity) is enabled, leading to more efficient utilization of network resources and increased support for low-capability devices.

In some aspects, the UE may identify the SSB bandwidth configuration and/or the CORESET bandwidth configuration based at least in part on a frequency of the SSB being on a synchronization raster for cells having the narrowband channel bandwidth. For example, if the SSB is on a frequency on a synchronization raster for cells having the narrowband channel bandwidth, the SSB bandwidth configuration and/or the CORESET bandwidth configuration may use a number of physical resource blocks or a set of excluded physical resource blocks associated with a standalone carrier. In some aspects, this number of physical resource blocks or set of excluded physical resource blocks may be derived from a table associated with the standalone carrier and the narrowband channel bandwidth.

Alternatively, the configuration information may indicate the SSB bandwidth configuration and/or the CORESET bandwidth configuration. For example, a carrier configuration of the SCell, a PDCCH configuration of the SCell, and/or a measurement object configuration of the SCell may indicate the SSB bandwidth configuration and/or the CORESET.

Aspects of the present disclosure may be used to realize one or more of the following potential advantages. In some aspects, by identifying the SSB bandwidth configuration and/or the CORESET bandwidth configuration based at least in part on a frequency of the SSB being on a synchronization raster for cells having the narrowband channel bandwidth, signaling overhead is reduced relative to explicitly indicating or configuring the SSB bandwidth configuration and/or the CORESET bandwidth configuration. In some aspects, by indicating the SSB bandwidth configuration and/or the CORESET bandwidth configuration via the configuration information, flexibility of configuration of the SCell is improved.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

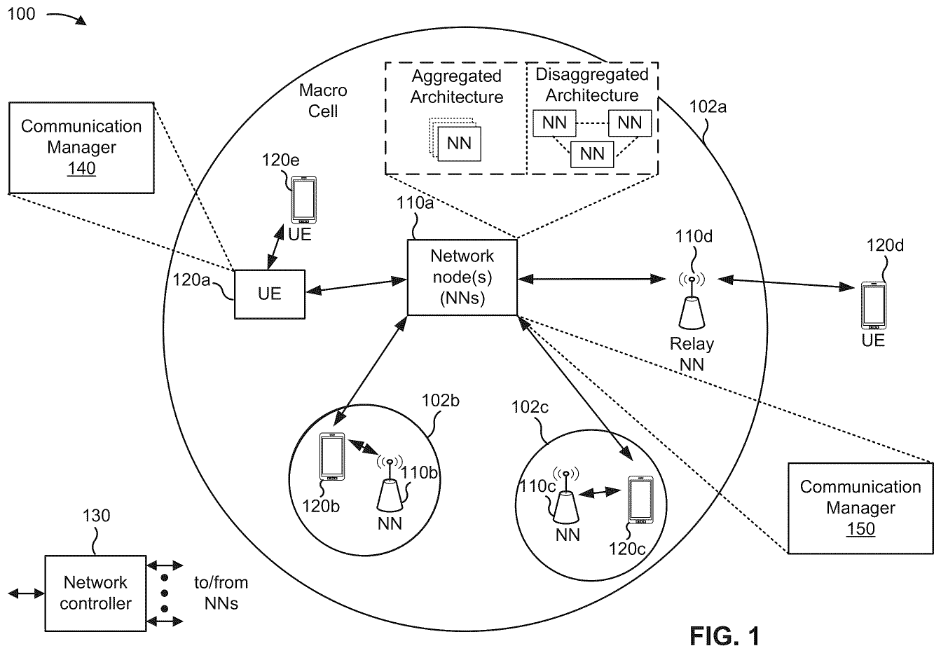

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive configuration information associated with an SCell, wherein the SCell has a narrowband channel bandwidth; receive an SSB on the SCell in accordance with an SSB bandwidth configuration, wherein the SSB bandwidth configuration is associated with at least one of: the configuration information, or a frequency of the SSB being identified by a synchronization raster, wherein the synchronization raster is for cells having the narrowband channel bandwidth; and monitor an initial CORESET using a CORESET bandwidth configuration associated with the configuration information. Additionally, or alternatively, the communication manager 140 may perform one or more other operations described herein.

In some aspects, the network node 110 may include a communication manager 150. As described in more detail elsewhere herein, the communication manager 150 may transmit configuration information associated with an SCell, wherein the SCell has a narrowband channel bandwidth; transmit an SSB on the SCell in accordance with an SSB bandwidth configuration, wherein the SSB bandwidth configuration is associated with at least one of: the configuration information, or a frequency of the SSB being identified by a synchronization raster for cells having the narrowband channel bandwidth; and transmit a communication on an initial CORESET using a CORESET bandwidth configuration associated with the configuration information. Additionally, or alternatively, the communication manager 150 may perform one or more other operations described herein.

As indicated above, FIG. 1 is provided as an example. Other examples may differ from what is described with regard to FIG. 1.

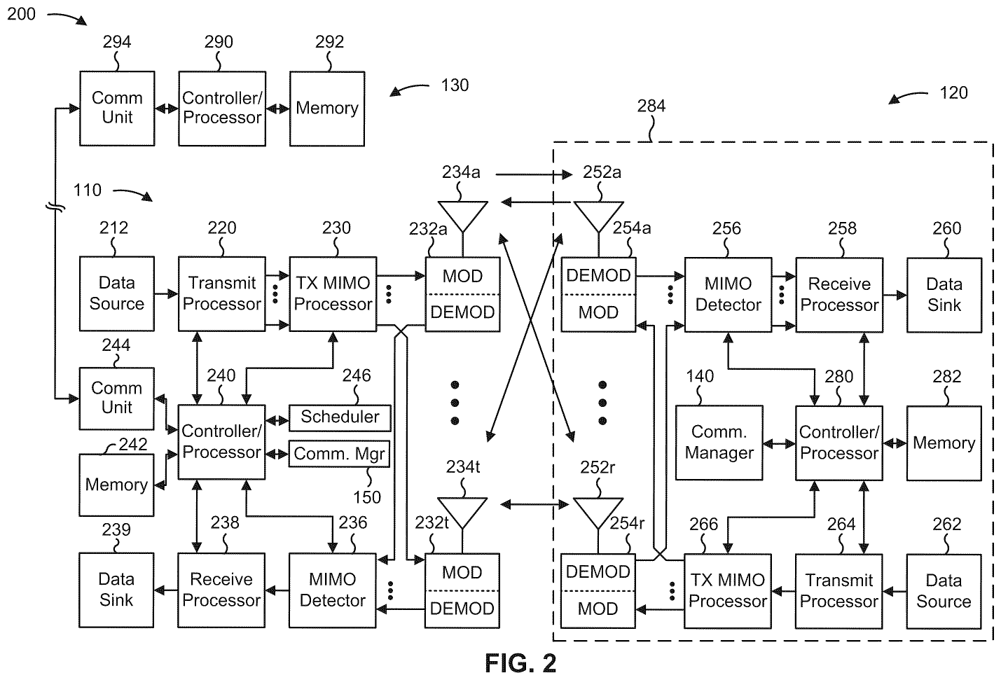

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

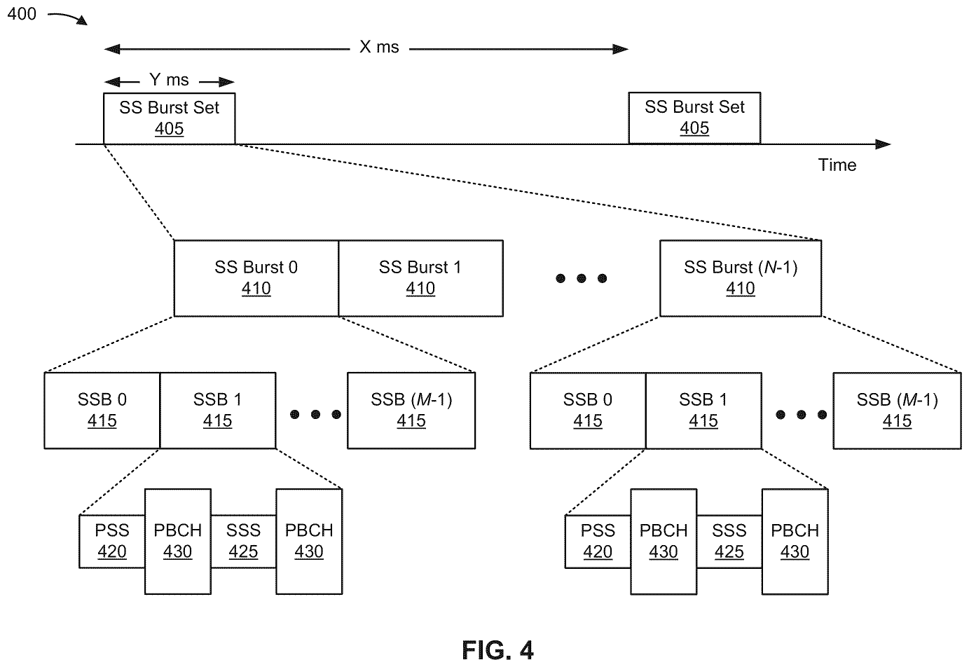

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-11).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-11).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

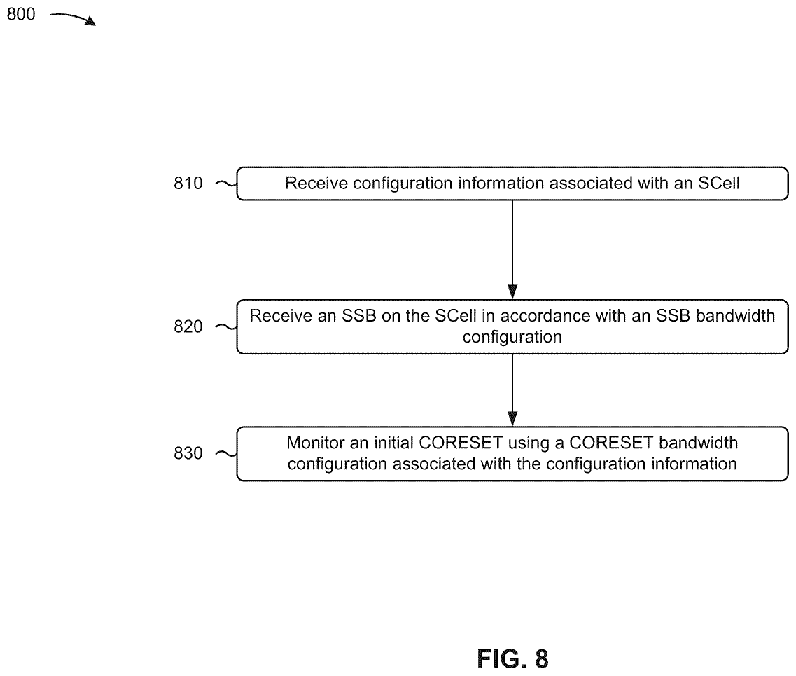

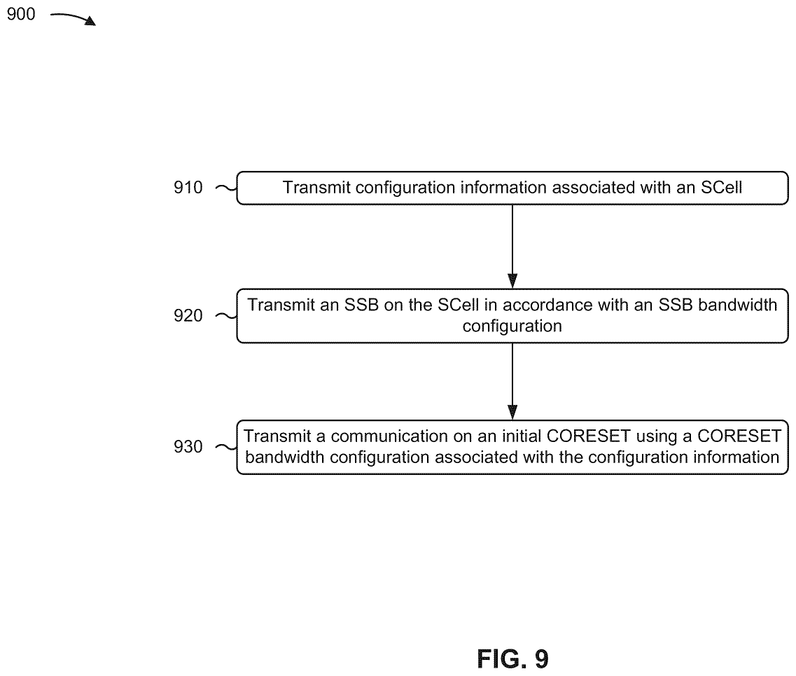

The controller/processor 240 of the network node 110, the controller/processor 280 of the UE 120, or any other component(s) of FIG. 2 may perform one or more techniques associated with SSB and CORESET indication for narrowband channel bandwidths, as described in more detail elsewhere herein. For example, the controller/processor 240 of the network node 110, the controller/processor 280 of the UE 120, or any other component(s) (or combinations of components) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving configuration information associated with an SCell, wherein the SCell has a narrowband channel bandwidth; means for receiving an SSB on the SCell in accordance with an SSB bandwidth configuration, wherein the SSB bandwidth configuration is associated with at least one of: the configuration information, or a frequency of the SSB being identified by a synchronization raster, wherein the synchronization raster is for cells having the narrowband channel bandwidth; and/or means for monitoring an initial CORESET using a CORESET bandwidth configuration associated with the configuration information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting configuration information associated with an SCell, wherein the SCell has a narrowband channel bandwidth; means for transmitting an SSB on the SCell in accordance with an SSB bandwidth configuration, wherein the SSB bandwidth configuration is associated with at least one of: the configuration information, or a frequency of the SSB being identified by a synchronization raster for cells having the narrowband channel bandwidth; and/or means for transmitting a communication on an initial CORESET using a CORESET bandwidth configuration associated with the configuration information. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

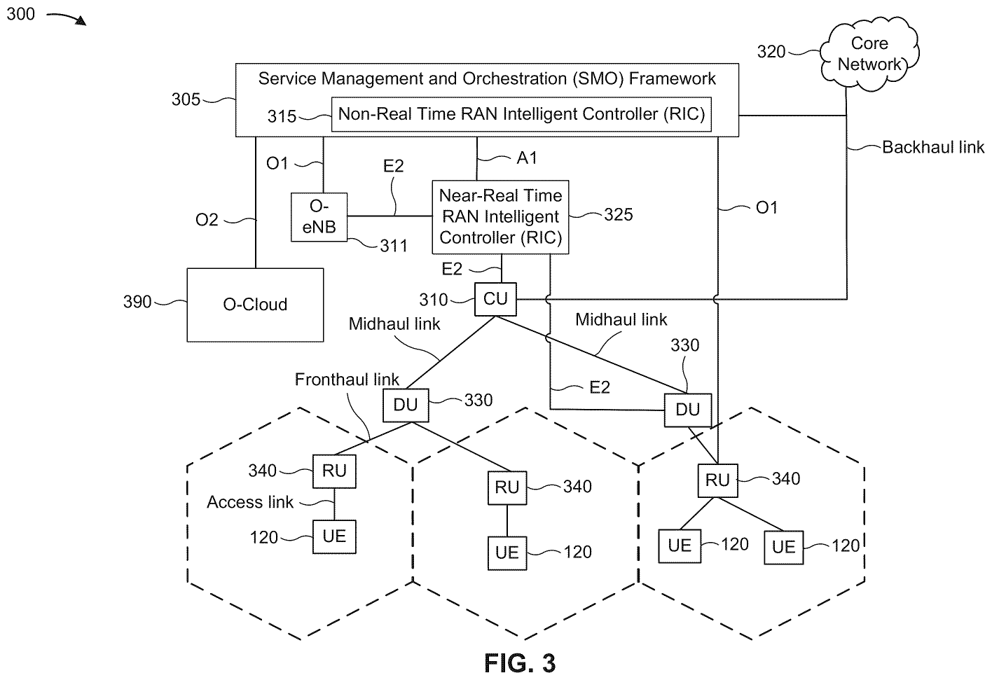

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of a synchronization signal (SS) hierarchy, in accordance with the present disclosure. As shown in FIG. 4, the SS hierarchy may include an SS burst set 405, which may include multiple SS bursts 410, shown as SS burst 0 through SS burst N−1, where N is a maximum number of repetitions of the SS burst 410 that may be transmitted by one or more network nodes. As further shown, each SS burst 410 may include one or more SS blocks (SSBs) 415, shown as SSB 0 through SSB M−1, where M is a maximum number of SSBs 415 that can be carried by an SS burst 410. In some aspects, different SSBs 415 may be beam-formed differently (e.g., transmitted using different beams), and may be used for cell search, cell acquisition, beam management, and/or beam selection (e.g., as part of an initial network access procedure). An SS burst set 405 may be periodically transmitted by a wireless node (e.g., a network node 110), such as every X milliseconds, as shown in FIG. 4. In some aspects, an SS burst set 405 may have a fixed or dynamic length, shown as Y milliseconds in FIG. 4. In some cases, an SS burst set 405 or an SS burst 410 may be referred to as a discovery reference signal (DRS) transmission window or an SSB measurement time configuration (SMTC) window.

In some aspects, an SSB 415 may include resources that carry a primary synchronization signal (PSS) 420, a secondary synchronization signal (SSS) 425, and/or a physical broadcast channel (PBCH) 430. In some aspects, multiple SSBs 415 are included in an SS burst 410 (e.g., with transmission on different beams), and the PSS 420, the SSS 425, and/or the PBCH 430 may be the same across each SSB 415 of the SS burst 410. In some aspects, a single SSB 415 may be included in an SS burst 410. In some aspects, the SSB 415 may be at least four symbols (e.g., OFDM symbols) in length, where each symbol carries one or more of the PSS 420 (e.g., occupying one symbol), the SSS 425 (e.g., occupying one symbol), and/or the PBCH 430 (e.g., occupying two symbols). In some aspects, an SSB 415 may be referred to as an SS/PBCH block.

In some aspects, the symbols of an SSB 415 are consecutive, as shown in FIG. 4. In some aspects, the symbols of an SSB 415 are non-consecutive. Similarly, in some aspects, one or more SSBs 415 of the SS burst 410 may be transmitted in consecutive radio resources (e.g., consecutive symbols) during one or more slots. Additionally, or alternatively, one or more SSBs 415 of the SS burst 410 may be transmitted in non-consecutive radio resources.

In some aspects, the SS bursts 410 may have a burst period, and the SSBs 415 of the SS burst 410 may be transmitted by a wireless node (e.g., a network node 110) according to the burst period. In this case, the SSBs 415 may be repeated during each SS burst 410. In some aspects, the SS burst set 405 may have a burst set periodicity, whereby the SS bursts 410 of the SS burst set 405 are transmitted by the wireless node according to the fixed burst set periodicity. In other words, the SS bursts 410 may be repeated during each SS burst set 405.

In some aspects, an SSB 415 may include an SSB index, which may correspond to a beam used to carry the SSB 415. A UE 120 may monitor for and/or measure SSBs 415 using different receive (Rx) beams during an initial network access procedure and/or a cell search procedure, among other examples. Based at least in part on the monitoring and/or measuring, the UE 120 may indicate one or more SSBs 415 with a best signal parameter (e.g., a reference signal received power (RSRP) parameter) to a network node 110 (e.g., directly or via one or more other network nodes). The network node 110 and the UE 120 may use the one or more indicated SSBs 415 to select one or more beams to be used for communication between the network node 110 and the UE 120 (e.g., for a random access channel (RACH) procedure). Additionally, or alternatively, the UE 120 may use the SSB 415 and/or the SSB index to determine a cell timing for a cell via which the SSB 415 is received (e.g., a serving cell).

An SSB 415 may have a bandwidth. The bandwidth may be expressed in terms of resource blocks (RBs). In some aspects, the bandwidth may represent a bandwidth of the SSB 415's PBCH. The bandwidth may be expressed in terms of RBs. At a subcarrier spacing (SCS) of 15 kHz and with a normal cyclic prefix, each RB has a bandwidth of 180 KHz. The bandwidth of an SSB 415 may be associated with a channel bandwidth of a cell on which the SSB is transmitted. An SSB 415 on a cell with a 5 MHz channel bandwidth (with a 25 RB bandwidth) may have a bandwidth of 20 RBs. For a 3 MHz channel bandwidth and a cell having a 12 RB bandwidth (e.g., on band n100), the SSB 415 may have a bandwidth of 12 RBs, and an upper 4 RBs and a lower 4 RBs of the SSB 415 may be punctured (e.g., excluded) to achieve the bandwidth of 12 RBs. For a 3 MHz channel bandwidth and a cell having a 15 RB bandwidth (e.g., on bands other than band n100), the SSB 415 may have a bandwidth of 12 RBs, and an upper 4 RBs and a lower 4 RBs of the SSB 415 may be punctured (e.g., excluded) to achieve the bandwidth of 12 RBs. For a 5 MHz channel bandwidth and a cell having a 20 RB bandwidth (e.g., on band n100), the SSB 415 may have a bandwidth of 20 RBs. Some of the channels described above may include a guard band, which may account for a difference between a sum of bandwidths of PRBs of the channel, and the total bandwidth of the channel.

As indicated above, FIG. 4 is provided as an example. Other examples may differ from what is described with regard to FIG. 4.

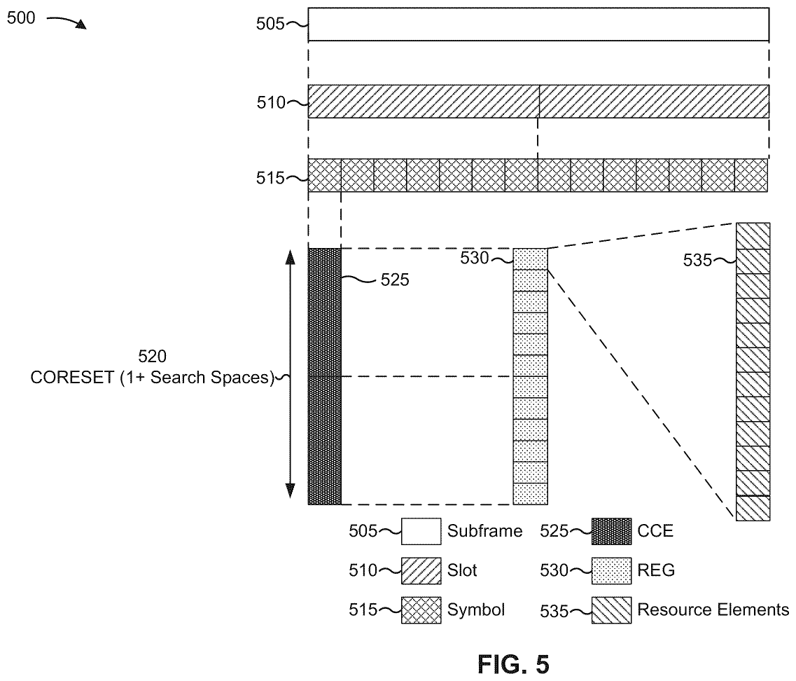

FIG. 5 is a diagram illustrating an example resource structure 500 for wireless communication, in accordance with the present disclosure. Resource structure 500 shows an example of various groups of resources described herein. As shown, resource structure 500 may include a subframe 505. Subframe 505 may include multiple slots 510. While resource structure 500 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes and/or slots. A slot 510 may include multiple symbols 515, such as 14 symbols per slot.

The potential control region of a slot 510 may be referred to as a CORESET 520 and may be structured to support an efficient use of resources, such as by flexible configuration or reconfiguration of resources of the CORESET 520 for one or more PDCCHs and/or one or more physical downlink shared channels (PDSCHs). In some aspects, the CORESET 520 may occupy the first symbol 515 of a slot 510, the first two symbols 515 of a slot 510, or the first three symbols 515 of a slot 510. Thus, a CORESET 520 may include multiple resource blocks (RBs) in the frequency domain, and either one, two, or three symbols 515 in the time domain. In 5G, a quantity of resources included in the CORESET 520 may be flexibly configured, such as by using radio resource control (RRC) signaling to indicate a frequency domain region (e.g., a quantity of resource blocks) and/or a time domain region (e.g., a quantity of symbols) for the CORESET 520.

As illustrated, a symbol 515 that includes CORESET 520 may include one or more control channel elements (CCEs) 525, shown as two CCEs 525 as an example, that span a portion of the system bandwidth. A CCE 525 may include downlink control information (DCI) that is used to provide control information for wireless communication. A base station may transmit DCI during multiple CCEs 525 (as shown), where the quantity of CCEs 525 used for transmission of DCI represents the aggregation level (AL) used by the BS for the transmission of DCI. In FIG. 5, an aggregation level of two is shown as an example, corresponding to two CCEs 525 in a slot 510. In some aspects, different aggregation levels may be used, such as 1, 2, 4, 8, 16, or another aggregation level.

Each CCE 525 may include a fixed quantity of resource element groups (REGs) 530, shown as 6 REGs 530, or may include a variable quantity of REGs 530. In some aspects, the quantity of REGs 530 included in a CCE 525 may be specified by a REG bundle size. A REG 530 may include one resource block, which may include 12 resource elements (REs) 535 within a symbol 515. A resource element 535 may occupy one subcarrier in the frequency domain and one OFDM symbol in the time domain.

A search space may include all possible locations (e.g., in time and/or frequency) where a PDCCH may be located. A CORESET 520 may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set.

A CORESET 520 may be interleaved or non-interleaved. An interleaved CORESET 520 may have CCE-to-REG mapping such that adjacent CCEs are mapped to scattered REG bundles in the frequency domain (e.g., adjacent CCEs are not mapped to consecutive REG bundles of the CORESET 520). A non-interleaved CORESET 520 may have a CCE-to-REG mapping such that all CCEs are mapped to consecutive REG bundles (e.g., in the frequency domain) of the CORESET 520.

One type of CORESET is an initial CORESET, sometimes referred to as CORESET #0 or CORESET0. The initial CORESET may include a PDCCH with DCI indicating a configuration for receiving system information block (SIB) 1. For example, the UE 120 may monitor the initial CORESET according to various hypotheses to obtain DCI indicating the configuration to receive SIB1. The UE 120 may receive SIB1 according to the DCI.

A CORESET 520 may have a configured bandwidth. For example, the initial CORESET may have a configured bandwidth. In various examples, the configured bandwidth may be 12 RBs or 24 RBs. In some narrowband channel bandwidths, the configured bandwidth of the initial CORESET may be overridden (e.g., the initial CORESET may have a narrower bandwidth in such channel bandwidths). For example, given a 3 MHz channel bandwidth on band n100, a CORESET0 may have a 12 RB bandwidth (out of a 12 RB configured bandwidth). Given a 3 MHz channel bandwidth on a band other than band n100, a CORESET0 may have a 15 RB bandwidth (out of a 24 RB configured bandwidth), which may be achieved by puncturing (e.g., excluding) an upper 9 RBs of a 24 RB CORESET0. Given a 5 MHz channel bandwidth on band n100, a CORESET0 may have a 20 RB bandwidth (out of a 24 RB configured bandwidth), which may be achieved by puncturing (e.g., excluding) an upper 4 RBs of a 24 RB CORESET0. Given a 5 MHz channel bandwidth on a band other than band n100, a CORESET0 may have a 24 RB bandwidth.

Table 0 provides an example of configured bandwidths (N_{RB}^{CORESET}) and CORESET0 bandwidths for different indexes of a parameter. In some aspects, the parameter may be indicated in a PBCH of an SSB. Thus, the SSB may indicate a CORESET bandwidth configuration of the CORESET0. In some aspects, the parameter may be configured. For example, configuration information (e.g., configuration information 705, a PDCCH configuration) may indicate the parameter.

TABLE 0

| | SS/PBCH block | Number | Number of | | |
|---|---|---|---|---|---|
| | and CORESET | of RBs | Symbols | Offset | CORESET0 |
| Index | multiplexing pattern | N_{RB}^{CORESET} | N_{symb}^{CORESET} | (RBs) | bandwidth |
| 0 | 1 | 12 | 2 | 0 | 12 PRBs |
| 1 | 1 | 12 | 3 | 0 | 12 PRBs |
| 2 | 1 | 24 | 2 | 0 | 15 PRBs, |
| | | | | | interleaved |
| 3 | 1 | 24 | 2 | 2 | 15 PRBs, |
| | | | | | interleaved |
| 4 | 1 | 24 | 3 | 0 | 15 PRBs, |
| | | | | | interleaved |
| 5 | 1 | 24 | 3 | 2 | 15 PRBs, |
| | | | | | interleaved |
| 6 | 1 | 24 | 2 | 0 | 15 PRBs, |
| | | | | | non- |
| | | | | | interleaved |
| 7 | 1 | 24 | 2 | 2 | 15 PRBs, |
| | | | | | non- |
| | | | | | interleaved |
| 8 | 1 | 24 | 3 | 0 | 15 PRBs, |
| | | | | | non- |
| | | | | | interleaved |
| 9 | 1 | 24 | 3 | 2 | 15 PRBs, |
| | | | | | non- |
| | | | | | interleaved |
| 10 | 1 | 24 | 2 | 0 | 20 PRBs, |
| | | | | | interleaved |
| 11 | 1 | 24 | 3 | 0 | 20 PRBs, |
| | | | | | interleaved |

| | |
|---|---|
| 12 | Reserved |
| 13 | Reserved |
| 14 | Reserved |
| 15 | Reserved |

As shown in Table 0, indexes 0 through 11 are associated with CORESET bandwidth configurations indicating bandwidths of 12 PRBs, 15 PRBs, or 20 PRBs, corresponding to narrowband channel bandwidths. Thus, Table 0 may be considered a CORESET0 configuration table for narrowband channel bandwidths (e.g., channel bandwidths less than 5 MHz), also referred to as a narrowband CORESET configuration table. In some aspects, CORESET bandwidth configurations (or the corresponding indexes, or the bandwidths of the CORESET bandwidth configurations) may be associated with an SSB bandwidth configuration. For example, a CORESET bandwidth configuration indicating a CORESET #0 bandwidth of 12 PRBs or 15 PRBs may be associated with (e.g., mapped to) an SSB bandwidth of 12 PRBs. As another example, a CORESET bandwidth configuration indicating a CORESET #0 bandwidth of 20 PRBs may be associated with (e.g., mapped to) an SSB bandwidth of 20 PRBs.

As indicated above, FIG. 5 is provided as an example. Other examples may differ from what is described with respect to FIG. 5.

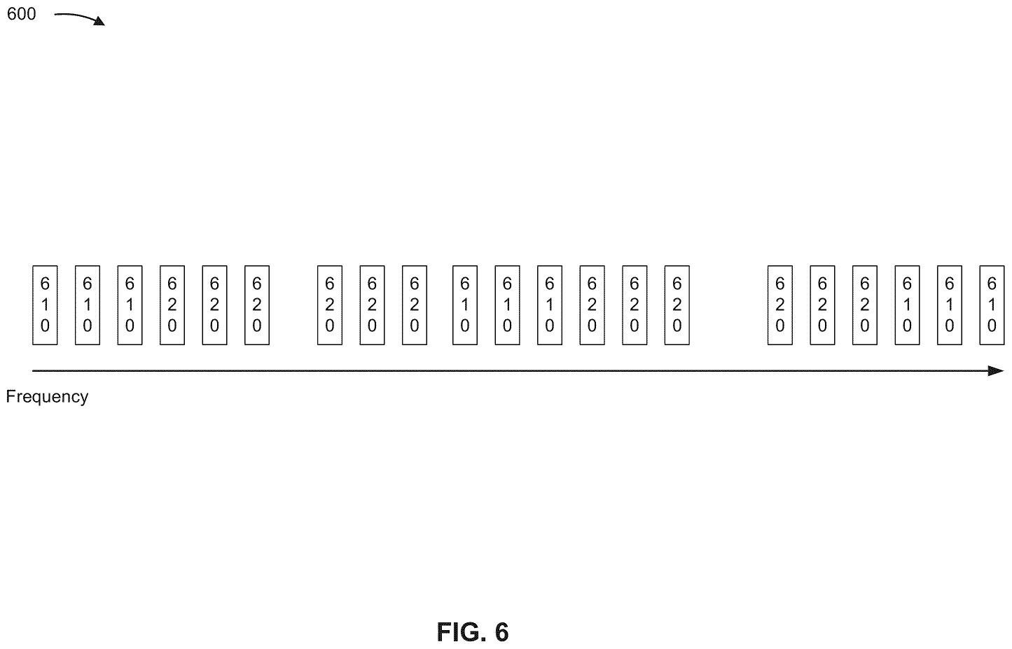

FIG. 6 is a diagram illustrating an example 600 of synchronization (sync) rasters, in accordance with the present disclosure. In the context of wireless communications, a sync raster may indicate a number of frequencies. A wireless communication device, such as a UE 120 or a network node 110, may communicate in accordance with the number of frequencies. For example, a communication (e.g., an SSB) may be mandated to occur on a frequency included in the number of frequencies. This may enable the UE to scan these frequencies and locate the communication without prior information regarding which frequency the communication will occur on.

In some RATs (e.g., 5G/NR), a sync raster may indicate the frequency positions of SSBs that can be used by the UE for system acquisition in the absence of explicit signaling of the SSB's location. A UE may be associated with multiple different sync rasters. For example, the UE may be associated with a first set of sync rasters 610 and a second set of sync rasters 620. Frequencies belonging to the first set of sync rasters 610 are indicated by the reference number “610.” Frequencies belonging to the second set of sync rasters 620 are indicated by the reference number “620.” The first set of sync rasters 610 may be defined by a first configuration and the second set of sync rasters 620 may be defined by a second configuration. For example, the first configuration may be associated with a first channel bandwidth (e.g., channel bandwidths above 3 MHz) and the second configuration may be associated with a second channel bandwidth (e.g., channel bandwidths of 3 MHZ). As another example, the second configuration may be associated with channel bandwidths between 3 MHz and 5 MHz (inclusive of 3 MHz). In some aspects, a particular band may be associated with its own sync raster. For example, band n100 (as defined by the 3GPP) may be associated with a specific sync raster (e.g., additional parameters defining the frequencies and global synchronization channel numbers (GSCNs) of the sync raster for band n100 may be specified separately from the first set of sync rasters 610 and the second set of sync rasters 620).

Frequencies of the first set of sync rasters 610 may not overlap frequencies of the second set of sync rasters 620. For example, each frequency of the first set of sync rasters 610 may overlap no frequencies of the second set of sync rasters 620, and vice versa. An SSB received on the first set of sync rasters 610 may be associated with a cell having a channel bandwidth above 3 MHz. An SSB received on the second set of sync rasters 620 may be associated with a cell having a channel bandwidth of 3 MHz. Thus, a UE receiving an SSB can differentiate the channel bandwidth of a cell that transmits the SSB.

In one example, the first set of sync rasters 610 may be defined by a first configuration indicated by Table 1, which illustrates GSCN parameters for the global frequency raster:

TABLE 1

| Frequency | SS Block frequency | | Range of |
|---|---|---|---|
| range | position SS_{REF} | GSCN | GSCN |
| 0-3000 MHz | N * 1200 kHz + M * 50 | 3N + | 2-7498 |
| | kHz, N = 1:2499, M ϵ | (M − 3)/2 | |
| | {1, 3, 5} (Note 1) | | |
| 3000-24250 MHz | 3000 MHz + N * 1.44 MHz | 7499 + N | 7499-22255 |
| | N = 0:14756 | | |

(NOTE 1):
The default value for operating bands with which there is support for SCS spaced channel raster(s) is M = 3.

In another example, the second set of sync rasters 620 may be defined by a second configuration indicated by Table 2, which illustrates GSCN parameters for narrowband channel bandwidths:

TABLE 2

| Range of | SS block frequency | | Range of |
|---|---|---|---|
| frequencies (MHz) | position SS_{REF} | GSCN | GSCN |
| 0-1000 | N * 600 kHz + M * | 26638 + 3N + | 26640-31634 |
| | 50 kHz + 300 kHz, | (M − 3)/2 | |
| | N = 1:1665, M ϵ | | |
| | {1, 3, 5} (Note 1) | | |

(NOTE 1):
Applicable for 15 PRB DCH transmission within 3 MHz channel bandwidth with punctured PBCH

As noted above, the position of an SSB can deviate from a frequency indicated by a sync raster. For example, for an SCell, the UE 120 may receive signaling that indicates a frequency position of the SSB. This frequency position may be on a sync raster or may be off of a sync raster (e.g., may correspond to no frequency identified by the sync raster). In some deployments, such as standalone deployments implementing only a PCell and a narrowband channel bandwidth, SSB bandwidth configurations and CORESET bandwidth configurations have been defined according to the sync raster (of the first set of sync rasters 610 or the second set of sync rasters 620) on which an SSB is received. It may be desirable to support implementation of narrowband channel bandwidths for SCells, such as to increase bandwidth and flexibility of configurations. However, an SCell's SSB can, in some cases, deviate from a sync raster that is used to derive an SSB bandwidth configuration and/or CORESET bandwidth configuration for a standalone deployment.

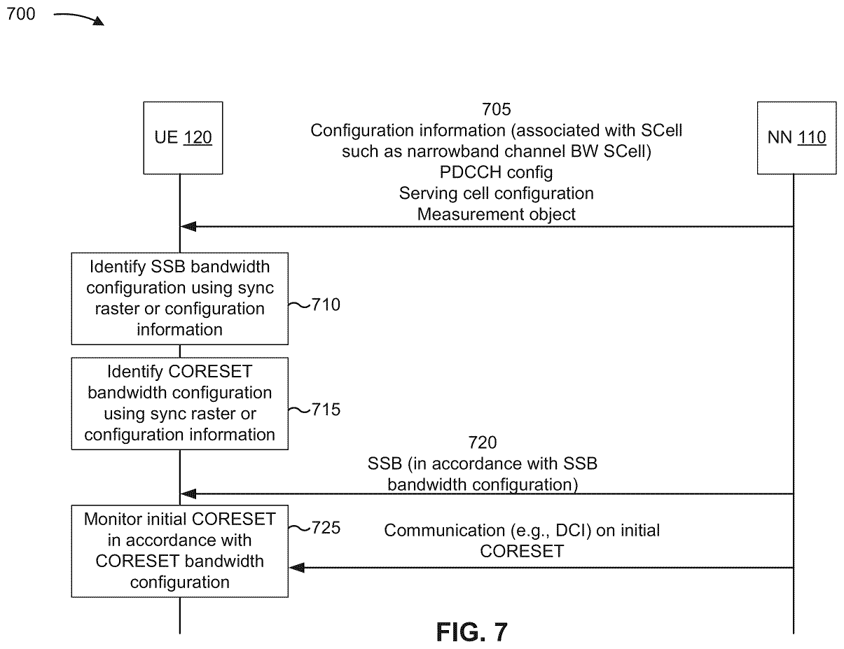

Some techniques described herein provide determination of a SSB bandwidth configuration and/or a CORESET bandwidth configuration for an SCell with a narrowband channel bandwidth. In some aspects, if the SSB (e.g., SSB 415) is on a sync raster (such as a frequency defined by the second set of sync rasters 620) (e.g., a sync raster specified for a standalone deployment), the SSB may have a particular SSB bandwidth configuration and/or CORESET bandwidth configuration (such as an SSB bandwidth configuration and/or CORESET bandwidth configuration specified for the standalone deployment). In some aspects, configuration information associated with the SCell may indicate the SSB bandwidth configuration and/or the CORESET bandwidth configuration, as described in connection with FIG. 7.

As indicated above, FIG. 6 is provided as an example. Other examples may differ from what is described with regard to FIG. 6.

FIG. 7 is a diagram illustrating an example 700 of signaling associated with SSB bandwidth configuration and/or CORESET bandwidth configuration indication, in accordance with the present disclosure. Example 700 includes a UE 120 and a network node 110. Some signaling in FIG. 7, such as the transmission and reception of the configuration information 705, may occur via a PCell. For example, the UE 120 and the network node 110 may have previously established a connection on the PCell.

As shown, the network node 110 may transmit, and the UE 120 may receive, configuration information 705. In some aspects, the configuration information 705 may be associated with an SCell. For example, the configuration information 705 May include a serving cell configuration (e.g., ServingCellConfigCommon) of the SCell, which may indicate one or more serving cell configuration parameters for the SCell. As another example, the configuration information 705 may include a downlink channel configuration, such as a PDCCH configuration (e.g., PDCCH-ConfigCommon) that indicates a PDCCH configuration parameter relating to a CORESET (e.g., an initial CORESET) on the SCell. As another example, the configuration information 705 may include a measurement object that is associated with performing a measurement on the SCell. In some aspects, the configuration information 705 may be transmitted via one or more of RRC signaling, medium access control signaling, DCI, or a combination thereof.

In some aspects, the configuration information 705 may indicate a frequency of an SSB of the SCell. In some aspects, the frequency may be on a sync raster for cells having a narrowband channel bandwidth (where narrowband channel bandwidth may include a bandwidth lower than 5 MHz such a bandwidth in a range including 3 MHz and not including 5 MHz). For example, the frequency may be on a sync raster of the first set of sync rasters 610, described with regard to FIG. 6. This may be considered a sync raster specified for a standalone deployment.

In some aspects, the serving cell configuration may indicate a serving cell configuration parameter (e.g., a parameter cc-bandwidth). This serving cell configuration parameter may indicate that a channel bandwidth of the SCell is a narrowband channel bandwidth. For example, the serving cell configuration parameter may indicate that the channel bandwidth of the SCell is less than 5 MHz. In some aspects, the serving cell configuration parameter may comprise one or more bits, such as two bits. The one or more bits may indicate the channel bandwidth of the SCell. A channel bandwidth of an SCell may indicate channel bandwidths usable by UEs 120 connected to the SCell. Example values of the one or more bits, and example SSB bandwidth configurations and/or CORESET bandwidth configurations indicated by the serving cell configuration parameter, are provided below.

In some aspects, the PDCCH configuration parameter may indicate that a channel bandwidth of the SCell is a narrowband channel bandwidth. For example, the PDCCH configuration parameter (e.g., ControlResourceSetZero-lessThan5 MHz) may indicate that the channel bandwidth of the SCell is a narrowband channel bandwidth. For example, the PDCCH configuration parameter may indicate that the channel bandwidth of the SCell is less than 5 MHz. In some aspects, an absence of the PDCCH configuration parameter may indicate that the channel bandwidth of the SCell is not a narrowband channel bandwidth (e.g., is at least 5 MHz). In some aspects, a different PDCCH configuration parameter (e.g., ControlResourceSetZero) being included in the configuration information 705 may indicate that the channel bandwidth of the SCell is not a narrowband channel bandwidth (e.g., is at least 5 MHz).

In some aspects, the measurement object (e.g., MeasObjectNR) may indicate an SSB bandwidth configuration. For example, a parameter of the measurement object (e.g., SSB-bandwidth-MO) may indicate that a bandwidth of the SSB is less than 20 RBs. In some aspects, a first value of the parameter may indicate that the SSB has a bandwidth of 20 RBs, and a second value of the parameter may indicate that the SSB has a bandwidth of 12 RBs. Additionally, or alternatively, a parameter value may identify a bandwidth with respect to a frequency range, a set of carriers, or another bandwidth identifier. As another example, the parameter may indicate that the bandwidth of the SSB is associated with cells having a narrowband channel bandwidth (e.g., the bandwidth of the SSB is 12 RBs, as may be used for cells having a channel bandwidth less than 5 MHz). The UE 120 may identify the SSB bandwidth configuration according to the parameter. For example, the UE 120 may identify a number of RBs (e.g., PRBs) comprising the bandwidth of the SSB (e.g., 12 RBs) and/or a set of RBs (e.g., PRBs) excluded (e.g., punctured) from the bandwidth of the SSB.

As shown by reference number 710, the UE 120 may identify an SSB bandwidth configuration. The SSB bandwidth configuration may indicate a number of RBs (e.g., PRBs) comprising the bandwidth of the SSB and/or a set of RBs (e.g., PRBs) excluded (e.g., punctured) from the bandwidth of the SSB. In some aspects, the SSB bandwidth configuration may be associated with a frequency of the SSB being identified by a synchronization raster, wherein the synchronization raster is for cells having the narrowband channel bandwidth. For example, if the frequency of the SSB is on a sync raster for cells having the narrowband channel bandwidth (e.g., the second set of sync rasters 620, which may for example be defined by Table 2), the UE 120 may identify the SSB bandwidth configuration in association with the sync raster. More particularly, the UE 120 may identify an SSB bandwidth configuration specified for a standalone deployment in this situation. For example, if an NR component carrier with a narrowband channel bandwidth is configured as an SCell (e.g., in an NR carrier aggregation deployment), and if an SSB of the SCell occurs on the sync raster for cells having the narrowband channel bandwidth and not on a sync raster for band n100, the SSB bandwidth configuration may indicate a 12 RB bandwidth and/or a set of RBs of a 20 RB SSB to be punctured to implement the 12 RB bandwidth (e.g., an upper 4 RBs and a lower 4 RBs).

In some aspects, the UE 120 may identify the SSB bandwidth configuration using the configuration information 705. For example, the network node 110 may be allowed to configure an SSB on a narrowband channel bandwidth's synchronization raster (e.g., set of sync rasters 620) that does not follow an SSB bandwidth configuration and/or CORESET bandwidth configuration specified for standalone deployment. In this example, the UE 120 may identify the SSB bandwidth configuration and/or the CORESET bandwidth configuration using the configuration information 705, as described in connection with reference numbers 710 and 715.

In some aspects, the UE 120 may identify the SSB bandwidth configuration using the serving cell configuration parameter. For example, the serving cell configuration parameter may indicate the SSB bandwidth configuration. As another example, the UE 120 may identify an SSB bandwidth configuration that corresponds to a channel bandwidth of the SCell, as indicated by the serving cell configuration parameter. As mentioned above, in some aspects, the serving cell configuration parameter may indicate the channel bandwidth and/or an SSB bandwidth configuration. Additionally, or alternatively, the serving cell configuration parameter may indicate the CORESET bandwidth configuration (described in more detail below). For example, the serving cell configuration parameter may explicitly indicate the SSB bandwidth configuration and/or the CORESET bandwidth configuration, or the UE 120 may derive the SSB bandwidth configuration and/or CORESET bandwidth configuration from the channel bandwidth indicated by the serving cell configuration parameter.

Table 3 shows an example of serving cell configuration parameters and channel bandwidths, SSB configuration parameters, and CORESET configuration parameters corresponding to the serving cell configuration parameters. Each serving cell configuration parameter in this example has a two-bit value, and corresponds to a channel bandwidth (where 20 PRBs, 15 PRBs, and 12 PRBs are narrowband channel bandwidths and 25 PRBs is not a narrowband channel bandwidth), an SSB bandwidth configuration, and a CORESET0 bandwidth configuration.

TABLE 3

| | Serving cell configuration | | | |
|---|---|---|---|---|
| | parameter (e.g., cc-bandwidth) | | | |
| | “00” | “01” | “10” | “11” |
| Channel bandwidth | >=25 PRBs | 20 PRBs | 15 PRBs | 12 PRBs |
| SSB bandwidth | 20 PRBs | 20 PRBs | 12 PRBs | 12 PRBs |
| configuration | | | | |
| CORESET0 | Based on non- | Based on | Based on | Based on |
| bandwidth | narrowband | narrowband | narrowband | narrowband |
| configuration | CORESET0 | CORESET0 | CORESET0 | CORESET0 |
| | config table | config table | config table | config table |

Reference to “narrowband CORESET0 config table” may refer, for example, to a table used to identify CORESET bandwidth configurations for cells having a narrowband channel bandwidth. One example of such a table is Table 0, described above. Reference to “non-narrowband CORESET0 config table” may refer, for example, to a CORESET0 configuration table for 5 MHz or greater channel bandwidths.

If the serving cell configuration parameter indicates a channel bandwidth of less than 25 PRBs (for example, values 01, 10, and 11 in Table 3), then the UE 120 may interpret an index of a PDCCH configuration parameter (such as ControlResourceSetZero of PDCCH-ConfigCommon) according to the narrowband CORESET0 configuration table (Table 0). If the serving cell configuration parameter does not indicate a channel bandwidth of less than 25 PRBs (for example, value 00 in Table 3), then the UE 120 may interpret an index of a PDCCH configuration parameter (such as ControlResourceSetZero of PDCCH-ConfigCommon) according to the non-narrowband CORESET0 configuration table. If the serving cell configuration parameter is absent in the serving cell configuration, the UE 120 may assume that the SCell has a non-narrowband channel bandwidth (e.g., the UE 120 may assume a value of 00 in Table 3).

In some aspects, the UE 120 may identify the SSB bandwidth configuration using the PDCCH configuration parameter. For example, the PDCCH configuration parameter (e.g., ControlResourceSetZero-lessThan5 MHz) may indicate that the channel bandwidth of the SCell is a narrowband channel bandwidth. If the PDCCH configuration parameter is not configured, the UE 120 may assume that the SCell has a non-narrowband channel bandwidth. In some aspects, the PDCCH configuration parameter may indicate whether the channel bandwidth of the SCell is a narrowband channel bandwidth. In some aspects, a first PDCCH configuration parameter (e.g., ControlResourceSetZero), if configured, may indicate that the channel bandwidth is not a narrowband channel bandwidth. In some aspects, a second PDCCH configuration parameter (e.g., ControlResourceSetZero-lessThan5 MHz), if configured, may indicate that the channel bandwidth is a narrowband channel bandwidth.

Table 4 provides an example of identifying an SSB bandwidth configuration and a CORESET bandwidth configuration based at least in part on the PDCCH configuration parameter (e.g., the first PDCCH configuration parameter or the second PDCCH configuration parameter).

TABLE 4

| | ControlResourceSetZero | ControlResourceSetZero- | None is |
|---|---|---|---|
| case | is configured | lessThan5 MHz is configured | configured |
| Channel BW | Non-narrowband (at least | Narrowband (less than | at least 5 MHz |
| | 5 MHz) | 5 MHz) | |
| SSB BW | 20 PRBs | determined from | 20 PRBs |
| CORESET0 | determined from | ControlResourceSetZero- | Not configured |
| BW | ControlResourceSetZero | lessThan5 MHz according | |
| | according to non- | to narrowband CORESET0 | |
| | narrowband table | config table (e.g., SSB BW | |
| Initial BWP | determined from initial | is 12 PRBs when | determined from |
| BW | BWP configuration | CORESET#0 BW is 12 or | initial BWP |
| | | 15 PRBs) | configuration |

In Table 4, if ControlResourceSetZero-lessThan5 MHz is configured, the UE 120 may determine an SSB bandwidth configuration (SSB BW) and/or a CORESET bandwidth configuration (CORESET0 BW) according to a narrowband CORESET0 configuration table, such as Table 0 described above. Furthermore, the UE 120 may determine an initial bandwidth part (BWP) bandwidth of an initial downlink BWP to be the same as the bandwidth of CORESET0. The UE 120 may determine the SSB bandwidth configuration and/or the CORESET bandwidth configuration based at least in part on an index of ControlResourceSetZero-lessThan5 MHz. For example, the UE may identify a row of Table 0 in accordance with the index, may identify a CORESET bandwidth configuration indicated by the row (e.g., 12 PRBs, 15 PRBs, or 20 PRBs), and may identify an SSB bandwidth configuration that corresponds to the row and/or the CORESET bandwidth configuration. In some aspects, the SSB bandwidth configuration may indicate a 12 PRB bandwidth if the CORESET0 has a bandwidth of 12 or 15 PRBs, and may indicate a 20 PRB bandwidth if the CORESET0 has a bandwidth of 20 PRBs. “RB” is generally used interchangeably with “PRB” herein. If ControlResourceSetZero is configured, the UE 120 may determine an SSB bandwidth configuration (SSB BW) and a CORESET bandwidth configuration (CORESET0 BW) according to a non-narrowband CORESET0 configuration table. If neither ControlResourceSetZero nor ControlResourceSetZero-lessThan5 MHz is configured, the UE 120 may identify an SSB bandwidth of 20 PRBs, and may identify a CORESET bandwidth configuration according to a received SSB (e.g., instead of the PDCCH configuration parameter).

In some aspects, the UE 120 may identify the SSB bandwidth configuration using a measurement object (e.g., MeasObjectNR, which may identify an SSB frequency, an SSB subcarrier spacing, and/or other parameters). For example, a first value (e.g., 0) of a parameter (e.g., SSB-bandwidth-MO) of the measurement object may indicate that the SSB has a bandwidth of 20 RBs, and a second value (e.g., 1) of the parameter of the measurement object may indicate that the SSB has a bandwidth of 12 RBs.

As shown by reference number 715, the UE 120 may identify a CORESET bandwidth configuration. The CORESET bandwidth configuration may indicate a bandwidth (e.g., a number of PRBs) and/or one or more excluded (e.g., punctured) PRBs of an initial CORESET (e.g., CORESET0). In some aspects, the CORESET bandwidth configuration may be associated with a frequency of the SSB being identified by a synchronization raster, wherein the synchronization raster is for cells having the narrowband channel bandwidth. For example, if the frequency of the SSB is on a sync raster for cells having the narrowband channel bandwidth (e.g., the second set of sync rasters 620, which may for example be defined by Table 2), the UE 120 may identify the CORESET bandwidth configuration in association with the sync raster. More particularly, the UE 120 may identify a CORESET bandwidth configuration specified for a standalone deployment in this situation. For example, if an NR component carrier with a narrowband channel bandwidth is configured as an SCell (e.g., in an NR carrier aggregation deployment), and if an SSB of the SCell occurs on the sync raster for cells having the narrowband channel bandwidth and not on a sync raster for band n100, the CORESET bandwidth configuration may indicate a 15 RB CORESET bandwidth and/or a set of RBs of a 24 RB CORESET to be punctured to implement the 15 RB bandwidth (e.g., an upper 9 RBs).

In some aspects, the UE 120 may identify the CORESET bandwidth configuration based at least in part on the configuration information 705, as described above with regard to reference number 710. For example, the UE 120 may identify the CORESET bandwidth configuration using a serving cell configuration parameter (e.g., cc-bandwidth), as described above with regard to Table 3. As another example, the UE 120 may identify the CORESET bandwidth configuration using a PDCCH configuration parameter, as described above with regard to Table 4.

As shown by reference number 720, the network node 110 may transmit, and the UE 120 may receive, an SSB. The SSB may be transmitted and received in accordance with the SSB bandwidth configuration (e.g., in accordance with a bandwidth and/or puncturing indicated by the SSB bandwidth configuration) and/or the configuration information 705 (e.g., at a frequency indicated by the configuration information 705, or the SSB bandwidth configuration may be indicated by the configuration information 705). In some aspects, the SSB may indicate a configuration for the initial CORESET, such as a location and/or bandwidth of the initial CORESET.

As shown by reference number 725, the UE 120 may monitor the initial CORESET using the CORESET bandwidth configuration (e.g., using a bandwidth of the initial CORESET and/or a set of excluded RBs indicated by the CORESET bandwidth configuration). The CORESET bandwidth configuration may be associated with the configuration information 705 in that the CORESET bandwidth configuration may be indicated by the configuration information 705 or may be derived from an SSB or SSB bandwidth configuration indicated by the configuration information 705. The network node 110 may transmit a communication, such as DCI, in the CORESET using the CORESET bandwidth configuration.

As indicated above, FIG. 7 is provided as an example. Other examples may differ from what is described with regard to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with SSB and CORESET indication.

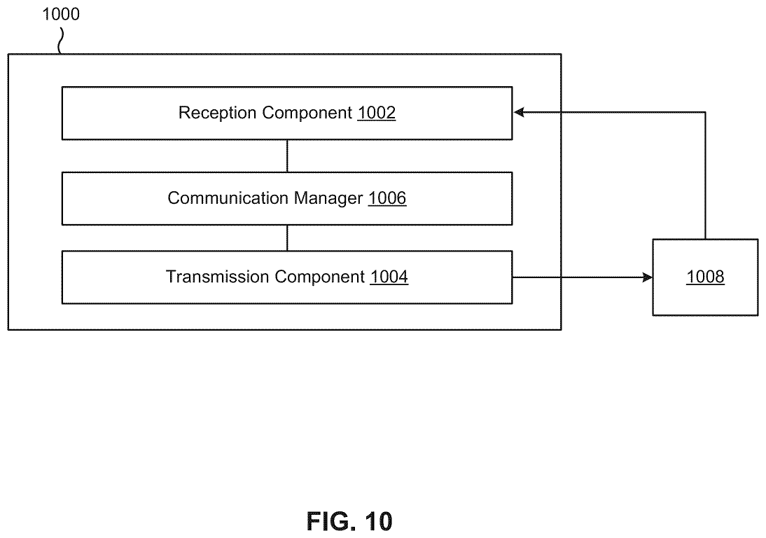

As shown in FIG. 8, in some aspects, process 800 may include receiving configuration information associated with an SCell, wherein the SCell has a narrowband channel bandwidth (block 810). For example, the apparatus or the UE (e.g., using reception component 1002 and/or communication manager 1006, depicted in FIG. 10) may receive configuration information associated with an SCell, as described above. In some aspects, the SCell has a narrowband channel bandwidth.

As further shown in FIG. 8, in some aspects, process 800 may include receiving an SSB on the SCell in accordance with an SSB bandwidth configuration (block 820). For example, the UE (e.g., using reception component 1002 and/or communication manager 1006, depicted in FIG. 10) may receive an SSB on the SCell in accordance with an SSB bandwidth configuration, as described above. In some aspects, the SSB bandwidth configuration is associated with at least one of: the configuration information, or a frequency of the SSB being identified by a synchronization raster. In some aspects, the synchronization raster is for cells having the narrowband channel bandwidth.

As further shown in FIG. 8, in some aspects, process 800 may include monitoring an initial CORESET using a CORESET bandwidth configuration associated with the configuration information (block 830). For example, the UE (e.g., using communication manager 1006, depicted in FIG. 10) may monitor an initial CORESET using a CORESET bandwidth configuration associated with the configuration information, as described above. In some aspects, the CORESET bandwidth configuration may be associated with the SSB. For example, the SSB may indicate at least part of the CORESET bandwidth configuration.

Process 800 may include additional aspects, such as any single aspect or any combination of aspects described below and/or in connection with one or more other processes described elsewhere herein.

In a first aspect, the SSB bandwidth configuration indicates at least one of a number of physical resource blocks comprising a bandwidth of the SSB, or a set of physical resource blocks that are excluded from the bandwidth of the SSB.

In a second aspect, alone or in combination with the first aspect, the CORESET bandwidth configuration indicates at least one of a number of physical resource blocks comprising a bandwidth of the initial CORESET, or a set of physical resource blocks that are excluded from the bandwidth of the initial CORESET.

In a third aspect, alone or in combination with one or more of the first and second aspects, in association with the SSB having the frequency on the synchronization raster for cells having the narrowband channel bandwidth, the SSB bandwidth configuration uses a number of physical resource blocks or a set of excluded physical resource blocks associated with a standalone carrier.

In a fourth aspect, alone or in combination with one or more of the first through third aspects, in association with the SSB having the frequency on the synchronization raster for cells having the narrowband channel bandwidth, the CORESET bandwidth configuration uses a number of physical resource blocks or a set of excluded physical resource blocks associated with a standalone carrier.

In a fifth aspect, alone or in combination with one or more of the first through fourth aspects, the configuration information indicates that a channel bandwidth of the SCell is less than 5 MHz.

In a sixth aspect, alone or in combination with one or more of the first through fifth aspects, the configuration information comprises a serving cell configuration parameter that indicates that the channel bandwidth of the SCell is less than 5 MHz.

In a seventh aspect, alone or in combination with one or more of the first through sixth aspects, the serving cell configuration parameter indicates at least one of the SSB bandwidth configuration or the CORESET bandwidth configuration.

In an eighth aspect, alone or in combination with one or more of the first through seventh aspects, the serving cell configuration parameter indicates at least one of the SSB bandwidth configuration or the CORESET bandwidth configuration in association with a table associated with cells having the narrowband channel bandwidth.

In a ninth aspect, alone or in combination with one or more of the first through eighth aspects, the configuration information comprises a physical downlink control channel configuration parameter that indicates that the channel bandwidth of the SCell is less than 5 MHz.

In a tenth aspect, alone or in combination with one or more of the first through ninth aspects, the physical downlink control channel configuration parameter indicates at least one of the SSB bandwidth configuration or the CORESET bandwidth configuration.

In an eleventh aspect, alone or in combination with one or more of the first through tenth aspects, the physical downlink control channel configuration parameter indicates at least one of the SSB bandwidth configuration or the CORESET bandwidth configuration in association with a table associated with cells having channel bandwidths less than 5 MHz.

In a twelfth aspect, alone or in combination with one or more of the first through eleventh aspects, the configuration information indicates that a bandwidth of the SSB is associated with cells having the narrowband channel bandwidth.

In a thirteenth aspect, alone or in combination with one or more of the first through twelfth aspects, the configuration information comprises a measurement object.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with SSB and CORESET indication.

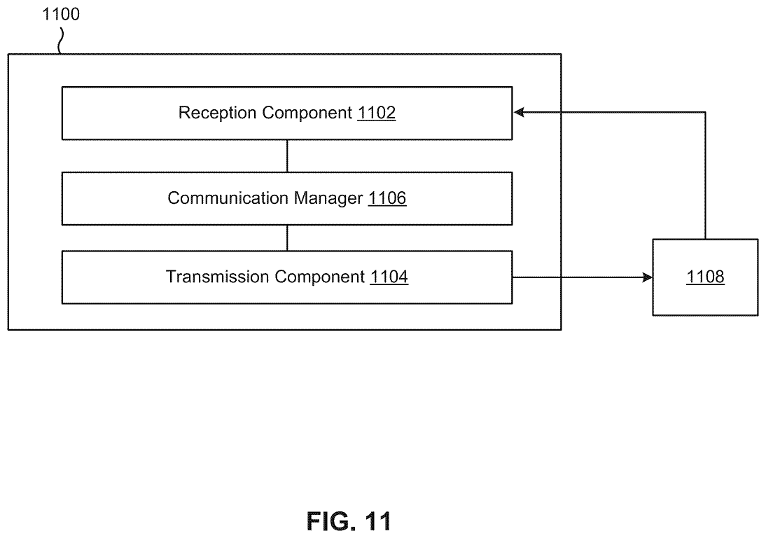

As shown in FIG. 9, in some aspects, process 900 may include transmitting configuration information associated with an SCell (block 910). For example, the network node (e.g., using transmission component 1104 and/or communication manager 1106, depicted in FIG. 11) may transmit configuration information associated with an SCell, as described above. In some aspects, the SCell has a narrowband channel bandwidth.

As further shown in FIG. 9, in some aspects, process 900 may include transmitting an SSB on the SCell in accordance with an SSB bandwidth configuration (block 920). For example, the apparatus or the network node (e.g., using transmission component 1104 and/or communication manager 1106, depicted in FIG. 11) may transmit an SSB on the SCell in accordance with an SSB bandwidth configuration, as described above. In some aspects, the SSB bandwidth configuration is associated with at least one of: the configuration information, or a frequency of the SSB being identified by a synchronization raster for cells having the narrowband channel bandwidth.

As further shown in FIG. 9, in some aspects, process 900 may include transmitting a communication on an initial CORESET using a CORESET bandwidth configuration associated with the configuration information (block 930). For example, the apparatus or the network node (e.g., using transmission component 1104 and/or communication manager 1106, depicted in FIG. 11) may transmit a communication on an initial CORESET using a CORESET bandwidth configuration associated with the configuration information, as described above.

Process 900 may include additional aspects, such as any single aspect or any combination of aspects described below and/or in connection with one or more other processes described elsewhere herein.

In a first aspect, the SSB bandwidth configuration indicates at least one of a number of physical resource blocks comprising a bandwidth of the SSB, or a set of physical resource blocks that are excluded from the bandwidth of the SSB.

In a second aspect, alone or in combination with the first aspect, the CORESET bandwidth configuration indicates at least one of a number of physical resource blocks comprising a bandwidth of the initial CORESET, or a set of physical resource blocks that are excluded from the bandwidth of the initial CORESET.

In a third aspect, alone or in combination with one or more of the first and second aspects, in association with the SSB having the frequency on the synchronization raster for cells having the narrowband channel bandwidth, the SSB bandwidth configuration uses a number of physical resource blocks or a set of excluded physical resource blocks associated with a standalone carrier.

In a fourth aspect, alone or in combination with one or more of the first through third aspects, in association with the SSB having the frequency on the synchronization raster for cells having the narrowband channel bandwidth, the CORESET bandwidth configuration uses a number of physical resource blocks or a set of excluded physical resource blocks associated with a standalone carrier.

In a fifth aspect, alone or in combination with one or more of the first through fourth aspects, the configuration information indicates that a channel bandwidth of the SCell is less than 5 MHz.

In a sixth aspect, alone or in combination with one or more of the first through fifth aspects, the configuration information comprises a serving cell configuration parameter that indicates that the channel bandwidth of the SCell is less than 5 MHz.

In a seventh aspect, alone or in combination with one or more of the first through sixth aspects, the serving cell configuration parameter indicates at least one of the SSB bandwidth configuration or the CORESET bandwidth configuration.

In an eighth aspect, alone or in combination with one or more of the first through seventh aspects, the serving cell configuration parameter indicates at least one of the SSB bandwidth configuration or the CORESET bandwidth configuration in association with a table associated with cells having the narrowband channel bandwidth.

In a ninth aspect, alone or in combination with one or more of the first through eighth aspects, the configuration information comprises a physical downlink control channel configuration parameter that indicates that the channel bandwidth of the SCell is less than 5 MHz.

In a tenth aspect, alone or in combination with one or more of the first through ninth aspects, the physical downlink control channel configuration parameter indicates at least one of the SSB bandwidth configuration or the CORESET bandwidth configuration.

In an eleventh aspect, alone or in combination with one or more of the first through tenth aspects, the physical downlink control channel configuration parameter indicates at least one of the SSB bandwidth configuration or the CORESET bandwidth configuration in association with a table associated with cells having the narrowband channel bandwidth.

In a twelfth aspect, alone or in combination with one or more of the first through eleventh aspects, the configuration information indicates that a bandwidth of the SSB is associated with cells having the narrowband channel bandwidth.

In a thirteenth aspect, alone or in combination with one or more of the first through eleventh aspects, the configuration information comprises a measurement object.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4-7. Additionally, or alternatively, the apparatus 1000 may be configured to perform one or more processes described herein, such as process 800 of FIG. 8, process 900 of FIG. 9, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive configuration information associated with an SCell, wherein the SCell has a narrowband channel bandwidth. The reception component 1002 may receive an SSB on the SCell in accordance with an SSB bandwidth configuration, wherein the SSB bandwidth configuration is associated with at least one of the configuration information, or a frequency of the SSB being identified by a synchronization raster, wherein the synchronization raster is for cells having the narrowband channel bandwidth. The communication manager 1006 may monitor an initial CORESET using a CORESET bandwidth configuration associated with the configuration information.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-7. Additionally, or alternatively, the apparatus 1100 may be configured to perform one or more processes described herein, such as process 800 of FIG. 8, process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit configuration information associated with an SCell, wherein the SCell has a narrowband channel bandwidth. The transmission component 1104 may transmit an SSB on the SCell in accordance with an SSB bandwidth configuration, wherein the SSB bandwidth configuration is associated with at least one of the configuration information, or a frequency of the SSB being identified by a synchronization raster for cells having the narrowband channel bandwidth. The transmission component 1104 may transmit a communication on an initial CORESET using a CORESET bandwidth configuration associated with the configuration information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving configuration information associated with a secondary cell (SCell), wherein the SCell has a narrowband channel bandwidth; receiving a synchronization signal block (SSB) on the SCell in accordance with an SSB bandwidth configuration, wherein the SSB bandwidth configuration is associated with at least one of: the configuration information, or a frequency of the SSB being identified by a synchronization raster, wherein the synchronization raster is for cells having the narrowband channel bandwidth; and monitoring an initial control resource set (CORESET) using a CORESET bandwidth configuration associated with the configuration information.

Aspect 2: The method of Aspect 1, wherein the SSB bandwidth configuration indicates at least one of: a number of physical resource blocks comprising a bandwidth of the SSB, or a set of physical resource blocks that are excluded from the bandwidth of the SSB.

Aspect 3: The method of any of Aspects 1-2, wherein the CORESET bandwidth configuration indicates at least one of: a number of physical resource blocks comprising a bandwidth of the initial CORESET, or a set of physical resource blocks that are excluded from the bandwidth of the initial CORESET.

Aspect 4: The method of any of Aspects 1-3, wherein, in association with the SSB having the frequency on the synchronization raster for cells having the narrowband channel bandwidth, the SSB bandwidth configuration uses a number of physical resource blocks or a set of excluded physical resource blocks associated with a standalone carrier.

Aspect 5: The method of any of Aspects 1-4, wherein, in association with the SSB having the frequency on the synchronization raster for cells having the narrowband channel bandwidth, the CORESET bandwidth configuration uses a number of physical resource blocks or a set of excluded physical resource blocks associated with a standalone carrier.

Aspect 6: The method of any of Aspects 1-5, wherein the configuration information indicates that a channel bandwidth of the SCell is less than 5 MHz.

Aspect 7: The method of Aspect 6, wherein the configuration information comprises a serving cell configuration parameter that indicates that the channel bandwidth of the SCell is less than 5 MHz.

Aspect 8: The method of Aspect 7, wherein the serving cell configuration parameter indicates at least one of the SSB bandwidth configuration or the CORESET bandwidth configuration.

Aspect 9: The method of Aspect 8, wherein the serving cell configuration parameter indicates at least one of the SSB bandwidth configuration or the CORESET bandwidth configuration in association with a table associated with cells having the narrowband channel bandwidth.

Aspect 10: The method of Aspect 6, wherein the configuration information comprises a physical downlink control channel configuration parameter that indicates that the channel bandwidth of the SCell is less than 5 MHz.

Aspect 11: The method of Aspect 10, wherein the physical downlink control channel configuration parameter indicates at least one of the SSB bandwidth configuration or the CORESET bandwidth configuration.

Aspect 12: The method of Aspect 11, wherein the physical downlink control channel configuration parameter indicates at least one of the SSB bandwidth configuration or the CORESET bandwidth configuration in association with a table associated with cells having channel bandwidths less than 5 MHz.

Aspect 13: The method of any of Aspects 1-12, wherein the configuration information indicates that a bandwidth of the SSB is associated with cells having the narrowband channel bandwidth.

Aspect 14: The method of Aspect 13, wherein the configuration information comprises a measurement object.

Aspect 15: A method of wireless communication performed by a network node, comprising: transmitting configuration information associated with a secondary cell (SCell), wherein the SCell has a narrowband channel bandwidth; transmitting a synchronization signal block (SSB) on the SCell in accordance with an SSB bandwidth configuration, wherein the SSB bandwidth configuration is associated with at least one of: the configuration information, or a frequency of the SSB being identified by a synchronization raster for cells having the narrowband channel bandwidth; and transmitting a communication on an initial control resource set (CORESET) using a CORESET bandwidth configuration associated with the configuration information.

Aspect 16: The method of Aspect 15, wherein the SSB bandwidth configuration indicates at least one of: a number of physical resource blocks comprising a bandwidth of the SSB, or a set of physical resource blocks that are excluded from the bandwidth of the SSB.

Aspect 17: The method of any of Aspects 15-16, wherein the CORESET bandwidth configuration indicates at least one of: a number of physical resource blocks comprising a bandwidth of the initial CORESET, or a set of physical resource blocks that are excluded from the bandwidth of the initial CORESET.

Aspect 18: The method of any of Aspects 15-17, wherein, in association with the SSB having the frequency on the synchronization raster for cells having the narrowband channel bandwidth, the SSB bandwidth configuration uses a number of physical resource blocks or a set of excluded physical resource blocks associated with a standalone carrier.

Aspect 19: The method of any of Aspects 15-18, wherein, in association with the SSB having the frequency on the synchronization raster for cells having the narrowband channel bandwidth, the CORESET bandwidth configuration uses a number of physical resource blocks or a set of excluded physical resource blocks associated with a standalone carrier.

Aspect 20: The method of any of Aspects 15-19, wherein the configuration information indicates that a channel bandwidth of the SCell is less than 5 MHz.

Aspect 21: The method of Aspect 20, wherein the configuration information comprises a serving cell configuration parameter that indicates that the channel bandwidth of the SCell is less than 5 MHz.

Aspect 22: The method of Aspect 21, wherein the serving cell configuration parameter indicates at least one of the SSB bandwidth configuration or the CORESET bandwidth configuration.

Aspect 23: The method of Aspect 22, wherein the serving cell configuration parameter indicates at least one of the SSB bandwidth configuration or the CORESET bandwidth configuration in association with a table associated with cells having the narrowband channel bandwidth.

Aspect 24: The method of Aspect 20, wherein the configuration information comprises a physical downlink control channel configuration parameter that indicates that the channel bandwidth of the SCell is less than 5 MHz.

Aspect 25: The method of Aspect 24, wherein the physical downlink control channel configuration parameter indicates at least one of the SSB bandwidth configuration or the CORESET bandwidth configuration.

Aspect 26: The method of Aspect 25, wherein the physical downlink control channel configuration parameter indicates at least one of the SSB bandwidth configuration or the CORESET bandwidth configuration in association with a table associated with cells having the narrowband channel bandwidth.

Aspect 27: The method of any of Aspects 15-26, wherein the configuration information indicates that a bandwidth of the SSB is associated with cells having the narrowband channel bandwidth.

Aspect 28: The method of Aspect 27, wherein the configuration information comprises a measurement object.

Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.

Aspect 30: An apparatus for wireless communication at a device, the apparatus comprising one or more memories and one or more processors coupled to the one or more memories, the one or more processors configured to cause the device to perform the method of one or more of Aspects 1-28.

Aspect 31: An apparatus for wireless communication, the apparatus comprising at least one means for performing the method of one or more of Aspects 1-28.

Aspect 32: A non-transitory computer-readable medium storing code for wireless communication, the code comprising instructions executable by one or more processors to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

Aspect 34: A device for wireless communication, the device comprising a processing system that includes one or more processors and one or more memories coupled with the one or more processors, the processing system configured to cause the device to perform the method of one or more of Aspects 1-28.

Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication at a user equipment (UE), comprising:
one or more memories; and
one or more processors, coupled to the one or more memories, configured to cause the UE to:
receive configuration information associated with a secondary cell (SCell), wherein the SCell has a narrowband channel bandwidth;
receive a synchronization signal block (SSB) on the SCell in accordance with an SSB bandwidth configuration, wherein the SSB bandwidth configuration is associated with at least one of:
the configuration information, or
a frequency of the SSB being identified by a synchronization raster, wherein the synchronization raster is for cells having the narrowband channel bandwidth; and
monitor an initial control resource set (CORESET) using a CORESET bandwidth configuration associated with the configuration information.

2. The apparatus of claim 1, wherein the SSB bandwidth configuration indicates at least one of:
a number of physical resource blocks comprising a bandwidth of the SSB, or
a set of physical resource blocks that are excluded from the bandwidth of the SSB.

3. The apparatus of claim 1, wherein the CORESET bandwidth configuration indicates at least one of:
a number of physical resource blocks comprising a bandwidth of the initial CORESET, or
a set of physical resource blocks that are excluded from the bandwidth of the initial CORESET.

4. The apparatus of claim 1, wherein, in association with the SSB having the frequency on the synchronization raster for cells having the narrowband channel bandwidth, the SSB bandwidth configuration uses a number of physical resource blocks or a set of excluded physical resource blocks associated with a standalone carrier.

5. The apparatus of claim 1, wherein, in association with the SSB having the frequency on the synchronization raster for cells having the narrowband channel bandwidth, the CORESET bandwidth configuration uses a number of physical resource blocks or a set of excluded physical resource blocks associated with a standalone carrier.

6. The apparatus of claim 1, wherein the configuration information indicates that a channel bandwidth of the SCell is less than 5 MHz.

7. The apparatus of claim 6, wherein the configuration information comprises a serving cell configuration parameter that indicates that the channel bandwidth of the SCell is less than 5 MHz.

8. The apparatus of claim 7, wherein the serving cell configuration parameter indicates at least one of the SSB bandwidth configuration or the CORESET bandwidth configuration.

9. The apparatus of claim 8, wherein the serving cell configuration parameter indicates at least one of the SSB bandwidth configuration or the CORESET bandwidth configuration in association with a table for cells having the narrowband channel bandwidth.

10. The apparatus of claim 6, wherein the configuration information comprises a physical downlink control channel configuration parameter that indicates that the channel bandwidth of the SCell is less than 5 MHz.

11. The apparatus of claim 10, wherein the physical downlink control channel configuration parameter indicates at least one of the SSB bandwidth configuration or the CORESET bandwidth configuration.

12. The apparatus of claim 11, wherein the physical downlink control channel configuration parameter indicates at least one of the SSB bandwidth configuration or the CORESET bandwidth configuration in association with a table associated with cells having channel bandwidths less than 5 MHz.

13. The apparatus of claim 1, wherein the configuration information indicates that a bandwidth of the SSB is associated with cells having the narrowband channel bandwidth.

14. The apparatus of claim 1, wherein the configuration information comprises a measurement object.

15. An apparatus for wireless communication at a network node, comprising:
one or more memories; and
one or more processors, coupled to the one or more memories, configured to cause the network node to:
transmit configuration information associated with a secondary cell (SCell), wherein the SCell has a narrowband channel bandwidth;
transmit a synchronization signal block (SSB) on the SCell in accordance with an SSB bandwidth configuration, wherein the SSB bandwidth configuration is associated with at least one of:
the configuration information, or
a frequency of the SSB being identified by a synchronization raster for cells having the narrowband channel bandwidth; and
transmit a communication on an initial control resource set (CORESET) using a CORESET bandwidth configuration associated with the configuration information.

16. The apparatus of claim 15, wherein the SSB bandwidth configuration indicates at least one of:
a number of physical resource blocks comprising a bandwidth of the SSB, or
a set of physical resource blocks that are excluded from the bandwidth of the SSB.

17. The apparatus of claim 15, wherein the CORESET bandwidth configuration indicates at least one of:
a number of physical resource blocks comprising a bandwidth of the initial CORESET, or
a set of physical resource blocks that are excluded from the bandwidth of the initial CORESET.

18. The apparatus of claim 15, wherein, in association with the SSB having the frequency on the synchronization raster for cells having the narrowband channel bandwidth, the SSB bandwidth configuration uses a number of physical resource blocks or a set of excluded physical resource blocks associated with a standalone carrier.

19. The apparatus of claim 15, wherein, in association with the SSB having the frequency on the synchronization raster for cells having the narrowband channel bandwidth, the CORESET bandwidth configuration uses a number of physical resource blocks or a set of excluded physical resource blocks associated with a standalone carrier.

20. A method of wireless communication performed by a user equipment (UE), comprising:
receiving configuration information associated with a secondary cell (SCell), wherein the SCell has a narrowband channel bandwidth;
receiving a synchronization signal block (SSB) on the SCell in accordance with an SSB bandwidth configuration, wherein the SSB bandwidth configuration is associated with at least one of:
the configuration information, or
a frequency of the SSB being identified by a synchronization raster, wherein the synchronization raster is for cells having the narrowband channel bandwidth; and
monitoring an initial control resource set (CORESET) using a CORESET bandwidth configuration associated with the configuration information.
